(19) United States
(12) Patent Application Publication
(10) Pub. No.: US 2019/0315483 A1
(43) Pub. Date: Oct. 17, 2019

(54) DEVICE AND METHOD FOR MANAGING SYSTEMS

(71) Applicant: THALES, Courbevoie (FR)

(72) Inventors: Sylvain LAPUYADE, Mérignac (FR); Véran HELSEN, Mérignac (FR); Jean-Marc LACOSTE, Mérignac (FR)

(21) Appl. No.: 16/380,868

(22) Filed: Apr. 10, 2019

(30) Foreign Application Priority Data
Apr. 12, 2018 (FR) 1800303

(51) Int. Cl. B64D 45/00; B64D 43/00; G06F 3/0484; G06F 3/041

(52) U.S. Cl. CPC B64D 45/00; B64D 43/00; B64D 2045/0085; G06F 3/0416; G06F 3/04847

(57) ABSTRACT

A method for managing systems, which includes at least a step for displaying a mimic diagram representation of the state of at least one system, the mimic diagram representation being composed of actuators and of links between the actuators, an actuator representing an element of the system that can be controlled. The method further comprises the steps of: detecting an interaction with an actuator; determining a number of controllable states for an element of the system represented by the actuator; configuring a multi-state interactor as a function of the number of controllable states and of the state of the system; and generating, on the state mimic diagram representation, a representation of the multi-state interactor including the commands available for controlling the element according to the state of the system.

### CROSS-REFERENCE TO RELATED APPLICATIONS

This application claims priority to foreign French patent application No. FR 1800303, filed on Apr. 12, 2018, the disclosure of which is incorporated by reference in its entirety.

### FIELD OF THE INVENTION

The invention relates to the field of systems management. In particular, the invention relates to a device and a method for managing aircraft systems.

### BACKGROUND

Aircraft cockpits are provided with complex display systems to represent several display zones simultaneously on screens. These systems are capable of displaying the information necessary to the management of the aeroplane and offer, among other things, functions for assisting in clearing failures of the aircraft, like the display of clearing procedures and the processing thereof.

The tasks of supervising the systems of the aircraft occupy the crew throughout the flight. For that, the pilot has system pages, representing the state of the systems in graphic form and an overhead panel containing the physical controls of the systems. All of these elements (system page and overhead panel) allow the pilot to supervise the state of the systems and to interact on:
the configuration of the systems of the aircraft, above all on the ground, but also in flight for the management of the de-icing systems and of the conditioned air systems; and
the reconfiguration of the systems in case of the detection of a failure, in order to deal with or limit the operational impact of the failure,
   in order to have an ongoing knowledge of the operational capabilities of the aeroplane and of the status of the aircraft.

In current aircraft, the controls that make it possible to manage all of the systems of the aircraft which supply or transmit the energy necessary to the operation of the aircraft (also called “utility systems” of an aircraft), are situated on an overhead panel, commonly referred to as OVHP (for “overhead panel”). This panel (102) is situated in a central position, in the cockpit (100), above the pilots, so as to be accessible to both pilots, as represented in FIG. 1.

These controls make it possible, by action of the pilot on physical knobs or rotary switches, to control the actuators. These actuators can be generators, gates, pumps, valves, or even more simply windscreen wipers. FIG. 2 gives an illustration of the different controls of a known overhead panel, such as the four main controls which are the hydraulics (202), the fuel (204), the electricity (206) and the conditioned air (208). Other controls are grouped together on the overhead panel, such as the engine, lighting, oxygen and other such controls.

The controls of the overhead panel are regularly actuated by the crew during a flight, regardless of the flight phase. A specific case is that of a system failure, for example of a loss of an electrical generator. Upon this type of technical event, the aim of the crew is to reconfigure the electrical energy distribution by actuating a certain number of switches via the electricity (206) controls of the overhead panel, in order to restore the supply to a part of these systems.

Concurrently with his or her actions on the controls of the overhead panel, the pilot must check the state of the corresponding utility system of the aircraft to ensure consistency between the controls of a system and the state of the system. In effect, upon a failure, a gate may be in an open state whereas its closure is demanded by its control. The states of the systems of an aircraft are generally represented in the form of a mimic diagram in the “SYSTEM” pages on the screens of the cockpit (104).

The pilot must visually go back and forth between the SYSTEM pages on the screens of the cockpit presenting the state of a system and the overhead panel giving access to the controls of the system. This then reveals a significant drawback due to the separation of access between the controls of a system situated on the overhead panel and the presentation of the state of the systems on the display screens in a central position in the cockpit. Indeed, the need to change visual context between the overhead panel and the screens of the cockpit induces a mental workload which can be detrimental to the understanding of a situation for which there may possibly need to be an urgent reaction. Thus, the fact that the various means allowing the management of the systems are dispersed in the cockpit leads to search and access problems, possibly problems of confusion and at worst of errors, among other things on the use of the controls of the overhead panel.

In addition, the overhead panel comprises a multitude of knobs on a limited surface, which results in a knob density such that it can lead to confusion at the time of the selection of the knob corresponding to the procedure to be applied, and may then become a source of errors. There is thus a real and positive risk of modifying the state of a knob incorrectly.

The behaviour of the pilots, particularly in case of major failure, can be critical, given the great complexity of the systems to be managed. Thus, the awareness of the situation and of the state of the systems of the aircraft is essential in order to comprehend the capabilities and the operational limitations of the aircraft, and be capable of anticipating or applying the requisite actions in the best conditions.

The recent arrival of touch technology in the cockpits is revealing solutions that aim to replace the physical controls of the overhead panel with virtualized controls.

For example, the patent application FR2935180 presents an interactive device for controlling the utilities in an aircraft. A software interface is used to display the representations of the accessible utility commands that can be controlled through the software interface. The software interface is configured to replace all or some of the knobs of the overhead panel. When the number of commands that are simultaneously accessible is too great, they are displayed in the form of multiple screen pages.

The “KORRY” solution proposed by the company ESTERLINE aims to replace the overhead panel with three touch screens. The user selects a system page and an interface proposes the commands. Even if this approach allows presenting only the commands linked to a context, the drawback is that the command and the mimic diagram of the state of the system are separate, and in the case of the execution of a procedure, that still requires the pilot:
to read the procedure on the screens;
to execute the action on the overhead panel; and
to correlate the overhead panel action with the state of the systems displayed on the SYSTEM page.

Also, there is no known solution which allows circumventing the problem resulting from the separation of the controls of a system from the state of the system. Thus, the technical problem of bringing the means supplying the state of the systems together with the means supplying the controls of the systems remains undiminished.

In particular, in the avionics field, the technical problem of bringing the means for viewing the SYSTEM pages displaying a mimic diagram of the state of an aircraft system together with an overhead panel giving access to the controls of the system is unresolved. By extension, the technical problem of the integration of any functional surface of a cockpit supplying the state of a system with the controls of the systems remains to be resolved.

There is then the need for a solution to incorporate, on one and the same interface, the controls of a system with a representation of the state of the system. The present invention addresses this need.

### SUMMARY OF THE INVENTION

An object of the present invention is a device providing an integrated representation of the state mimic diagram of a system with the controls of this system.

In a preferential implementation, the system is an aircraft system, but any system requiring a robust interaction with incorrect commands can benefit from the implementation of the present invention, such as, for example, a nuclear power plant console or a medical console.

Another object of the present invention is a method for integrating the controls of a system with a state mimic diagram of the system.

In an embodiment in the field of avionics, the present invention proposes a method for merging the controls of an overhead panel with the state mimic diagrams of the systems corresponding to the controls.

The invention also covers a display device comprising display means for graphically representing, on one and the same interface, the state of a system and the state of the corresponding controls of the system.

Advantageously, the proposed interface is robust to inadvertent presses, thereby avoiding the triggering of unwanted actions.

Again advantageously, the invention does not overload the mimic diagrams with information. In one embodiment, the invention allows to reveal only the non-nominal states of the system.

To obtain the results sought, methods, devices and a computer program product are described.

In particular, a method implemented by computer for managing systems is proposed, the method comprising at least a step for displaying a mimic diagram representation of the state of at least one system, said mimic diagram representation being composed of actuators and of links between the actuators, an actuator representing an element of the system that can be controlled, the method further comprising the steps of:
detecting an interaction with an actuator;
determining a number of controllable states for an element of the system represented by the actuator;
configuring a multi-state interactor as a function of the number of controllable states and of the state of said system; and
generating, on the state mimic diagram representation, a representation of the multi-state interactor including the commands available for controlling said element according to the state of said system.

According to embodiments of the method, alternatively or in combination:
the step of generating a representation of the interactor on the state mimic diagram representation consists in juxtaposing the representation of the multi-state interactor with the representation of the actuator;
the step of juxtaposing the representation of the interactor on the state mimic diagram representation consists in displaying said multi-state interactor on one and the same screen as the display of the state mimic diagram representation of said system;
the step of configuring the multi-state interactor consists in configuring an interactor having one or more sliders as a function of the number of controllable states, and the step of generating a representation of the interactor on the state mimic diagram representation consists in generating a cursor;
the cursor is composed of a slider with two commands for two controllable states or two sliders with three commands for three controllable states or three sliders with four commands for four controllable states;
the step of configuring the multi-state interactor further comprises a step of determining the current state of said system and the step of generating a representation of the multi-state interactor comprises a step for adapting the representation of the multi-state interactor as a function of the current state of said system;
the step of detecting an interaction with the actuator consists in detecting a press of single-touch type on the actuator;
the step of determining the number of controllable states comprises a step of identifying the element of said system which is controlled by the actuator;
a further step consists in determining that a command on the representation of the interactor is selected, and a step of applying the selected command to said element of said system;
a further step consists in updating the mimic diagram representation of the system if the command is executed, the updating consisting in modifying the representation of the state of the actuator according to its real state, and in replacing the representation of the multi-state interactor with an appropriate label when the selected command corresponds to a non-nominal state.

According to an embodiment of the method for an aircraft system, the step of displaying a mimic diagram representation of at least one system of the aircraft is a step of displaying a representation of flight parameters, said representation defining interactive display zones for each parameter, the method comprising the steps of:
detecting an interaction with a flight parameter display zone;
identifying the controllable system of the aircraft corresponding to the parameter of said display zone;
determining a number of controllable states for said system;
configuring a multi-state interactor as a function of the number of controllable states and of the state of said system; and
generating, on the state mimic diagram representation, a representation of the multi-state interactor including the commands available for controlling said element according to the state of said system.

The invention also covers a computer program product, said computer program comprising code instructions for performing the steps of the method claimed, when the program is run on a computer.

The invention additionally covers a device for managing systems, which comprises at least one control screen suitable for displaying a mimic diagram representation of the state of at least one system. The mimic diagram representation is composed of actuators and of links between the actuators, and the device further comprises means for:
detecting an interaction on an actuator;
determining a number of controllable states for an element of the system represented by the actuator;
configuring a multi-state interactor as a function of the number of controllable states and of the state of said system; and
generating, on the state mimic diagram representation, a representation of the multi-state interactor including the commands available for controlling said element according to the state of said system.

In an implementation for an aircraft system:
the mimic diagram representation of a system of the aircraft is a representation of a utility system such as, for example, an electrical system, a hydraulic system, a fuel or oxygen supply system, a conditioned air system or a lighting system;
the element that can be controlled represented by an actuator is for example a valve, a pump, a gate, a generator or windscreen wipers.

In an alternative embodiment of the device for managing the systems of an aircraft, the device comprises at least one screen for displaying a representation of flight parameters, said representation defining interactive display zones for each parameter, the device further comprises means for:
detecting an interaction with a flight parameter display zone;
identifying the controllable system of the aircraft corresponding to the parameter of said display zone;
determining a number of controllable states for said system;
configuring a multi-state interactor as a function of the number of controllable states and of the state of said system; and
generating, on the state mimic diagram representation, a representation of the multi-state interactor including the commands available for controlling said element according to the state of said system.

The flight parameters can relate to the altitude, speed and direction.

### BRIEF DESCRIPTION OF THE DRAWINGS

Different aspects and advantages of the invention will emerge in support of the description of a preferred but non limiting mode of implementation of the invention, with reference to the figures below:

FIG. 1 illustrates a known aircraft cockpit environment with a simplified representation of the control systems;

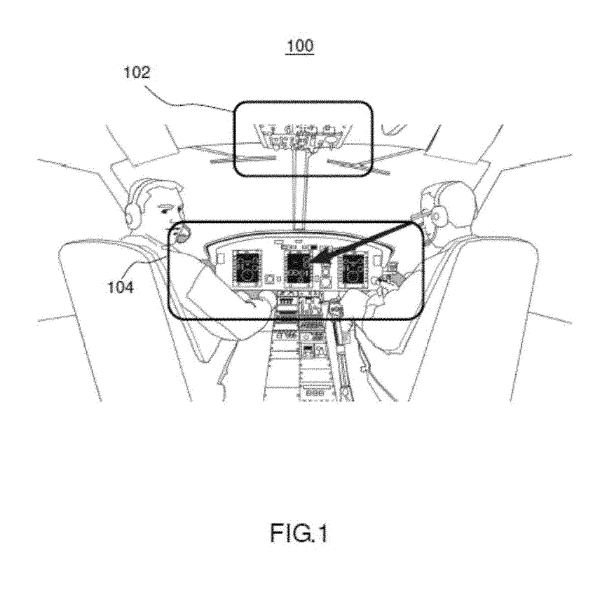

FIG. 2 illustrates different controls on a known overhead panel;

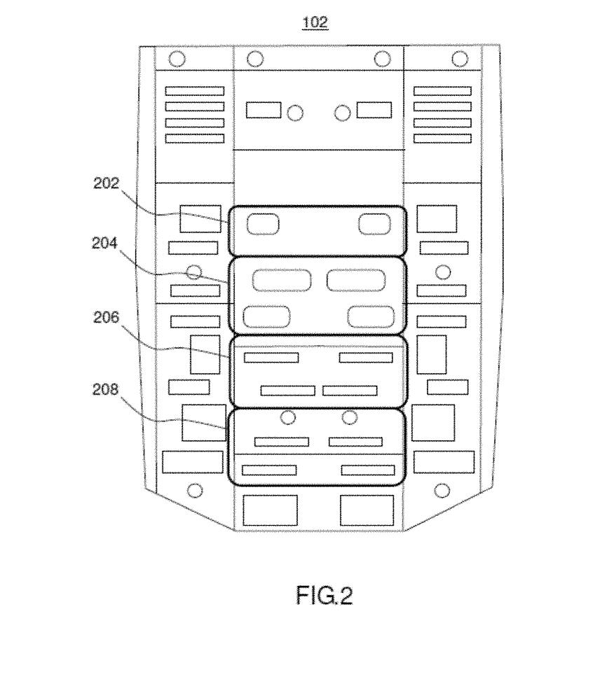

FIG. 3 shows an example of a mimic diagram of electrical distribution of an aircraft comprising actuators;

FIG. 4 illustrates examples of representations of different configurations of interactors according to embodiments of the invention;

FIG. 5 shows the steps of the method of the invention according to an embodiment;

FIG. 6 illustrates different controllable states of an element for an embodiment of an interactor according to the invention;

FIG. 7 illustrates mimic diagram representations of an actuator with the display of a label of the state of a control, according to the invention;

FIGS. 8a and 8b illustrate a display of a mimic diagram of a hydraulic system respectively before and after an interaction on an actuator;

FIG. 9 shows the steps of the method of the invention according to another embodiment;

FIG. 10 illustrates an implementation of the method of the invention of FIG. 9.

### DETAILED DESCRIPTION

Generally, the present invention proposes a device which offers a human-machine interface that is reliable, robust to inadvertent presses and that presents, in a concise and integrated manner, the controls of a system with the state of this system.

Without being limiting but to facilitate the understanding of the principles of the invention, the description is made for an aircraft system. Hereinafter in the description, the expression “systems of an aircraft” or “utility systems of an aircraft” are used without differentiation. In effect, although a preferential application of the present invention is for the utility systems on board an aircraft, the method can be generalized for any system for which it is advantageous to have an integrated view of the state of the system and of its controls. Thus, the method of the invention can be implemented to propose, on a touch surface, a human-machine interface having distinct functional zones with which a pilot can interact, each zone allowing the display, in a concise and integrated manner, of the controls and the state of a set of flight parameters of an aircraft.

In the context of the description, an aircraft is understood to be a transport means capable of moving in the Earth's atmosphere. For example, an aircraft can be an aeroplane or a helicopter. The aircraft comprises a piloting cabin or a cockpit in which are located the piloting equipment (called avionics equipment, certified by aeronautical regulator) and optional equipment (called non-avionic or “open world” equipment). The avionics systems can in particular comprise human-machine interfaces HMI or human-system interfaces HSI, one or more flight management systems of the aircraft, one or more mission management systems. An HMI/HSI interface can comprise one or more display screens. Advantageously, the invention exploits human-machine interaction systems that are modern, reliable and robust, and according to embodiments, the display means can be touch screens, with feedback, with augmented and/or virtual reality. The display means can comprise or implement one or more devices such as virtual reality headsets and/or augmented reality glasses (e.g. “head-mounted display”, “wearable computer”, “glasses” or a video headset) and/or projection devices (e.g. holographic). A virtual reality headset worn by a pilot can be opaque or semi-transparent or have configurable transparency. The display can be “head up”. The information can be displayed in one or more virtual and/or augmented reality headset(s). The information can therefore be entirely virtual (displayed in an individual headset), entirely real (for example projected onto the planar surfaces available in the real environment of the cockpit of the aircraft) or a combination of the two (partly a virtual display overlaid on or merged with the reality and partly a real display via projectors). The display can also be characterized by the application of predefined placement rules and display rules. For example, the human-machine interfaces (or the information) can be “distributed” (segmented into distinct portions, possibly partially redundant, then divided up) between the different virtual or real screens.

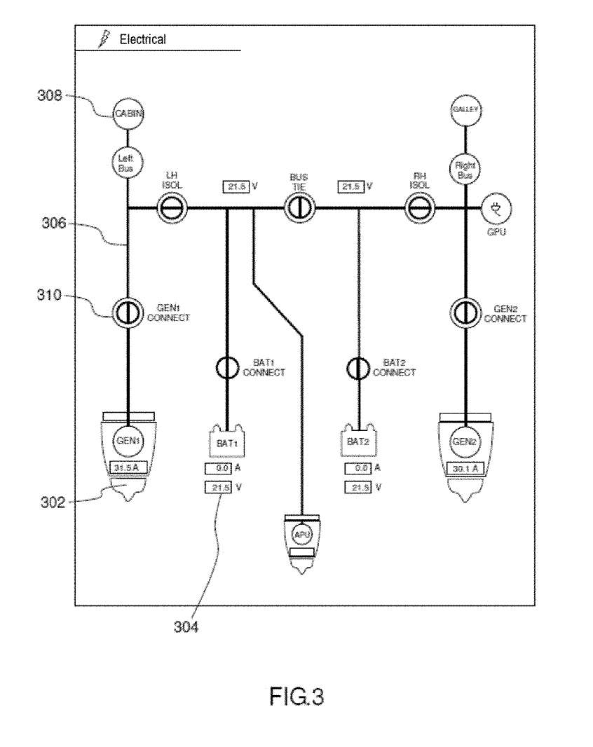

Referring to FIG. 3, an example of a mimic diagram of a utility system of an aircraft is illustrated. The mimic diagram taken as an example for the needs of the description is that of the electrical distribution as generally used for a commercial aircraft. There are however mimic diagrams for each system of the aircraft to be controlled, and the present invention applies for all the mimic diagrams and the controls of these systems. A mimic diagram of an electrical distribution system generally presents indicators of measurement (ampere (302) or voltage (304)) of electrical components, links (306) linking electrical components to systems of the aircraft that have to be electrically powered, such as the cabin (308) for example, and actuators (310) allowing the distribution or not of an electrical power supply over the path represented by the links. According to the principle of the invention, the actuators of the mimic diagram representations are no longer passive actuators but are interactive actuators. An interaction on an actuator, by virtue of the method of the invention, allows to display, on the same human-machine interface, an interactor with which the pilot can interact to apply the desired command, the interactor allowing access to only the available commands. The pilot can interact with the actuator or the interactor with any pointing device whether it be wired or not, or of touch type.

Advantageously, the interactor of the present invention is robust to incorrect activations, unlike any other interactor or menu or multiple choice type for example, because each command must be selected by a secure gesture. An example is described for a gesture on a simple slider, but the embodiment could use a more complex pattern, for example of broken line type.

Advantageously, the invention merges the state of the system (presented as mimic diagram) and the control of the system (presented by the interactor).

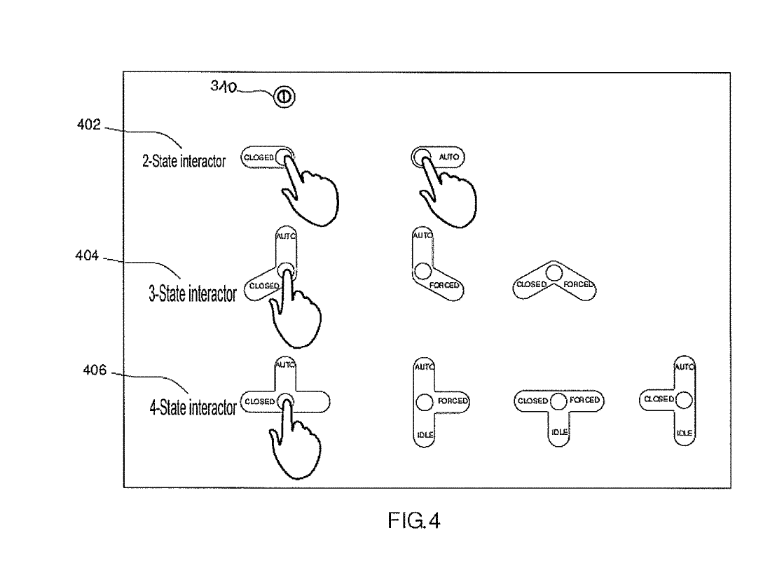

FIG. 4 illustrates examples of configurations (402, 404, 406) of interactors according to the invention. After an interaction on an interactor (310) presented on a mimic diagram, a multi-state interactor is juxtaposed on the actuator. In one embodiment, the multi-state interactor is composed of one or more sliders, the number of sliders representing the number of controllable states available for the remote system to be controlled.

In a first configuration (402) where the remote system linked with the actuator has two controllable states, the interactor is configured just one to present the two states on a slider. The two controllable states can be a nominal state and a degraded state. Preferentially, the implementation of the two-state configuration proposes the nominal states on the right of the slider, and the degraded states on the left. In the example of FIG. 4, the nominal state on the right is labelled “AUTO” and the degraded state on the left is labelled “CLOSED”. The two-state interactor selects one command out of the two by sliding a point of interaction (represented by a finger in the figure) from one side of the slider to the other.

In another configuration (404) where the remote system linked with the actuator has three controllable states the interactor is configured to present the three states on two sliders. The three controllable states can be a nominal state, a degraded state and a forced state. In the example of FIG. 4, the nominal state is labelled “AUTO”, the degraded state is labelled “CLOSED”, and the forced state is labelled “FORCED”. Preferentially, the implementation of the three-state configuration proposes an interactor of three-branch star type, where the branch corresponding to the current state is not displayed. Thus, for example, if the current state is the forced state, the interactor is configured to display only the other two controllable states, “AUTO” and “CLOSED”, as illustrated on the left-hand interactor of FIG. 4. The three-state interactor selects one command out of three by sliding a point of interaction (represented by a finger in the figure) to the side of the slider bearing the label of the command to be selected.

Another configuration that is illustrated (406) is that where the remote system linked with the actuator has four controllable states. The multi-state interactor is configured to present the four states on three sliders which make it possible to select one command out of four. The four controllable states can be a nominal state, a degraded state, a forced state and a standby state. In the example of FIG. 4, the nominal state is labelled “AUTO”, the degraded state is labelled “CLOSED”, the forced state is labelled “FORCED”, and the standby state is labelled “IDLE”. Preferentially, the implementation of the four-state configuration proposes an interactor of four-branch cross type, where the branch corresponding to the current state is not displayed. Thus, for example, if the current state is the standby state, the interactor is configured to display only the other three controllable states, “AUTO”, “CLOSED”, and “FORCED” as illustrated on the left-hand interactor of FIG. 4. The four-state interactor selects one command out of four by sliding a point of interaction (represented by a finger in the figure) to the side of the slider bearing the label of the command to be selected.

The person skilled in the art understands that only a few examples of representation of a multi-state interactor are illustrated, but other variants of graphic configurations can be used, where the interactor can have different forms, different colours, different command label displays. Likewise, the example is illustrated for a two to four-state multi-state interactor, but can be generalized for a greater number of controllable states. The generalization can relate to a number of controllable states corresponding to a combination of states of several subsystems that can for example be differentiated by combinations of interactors.

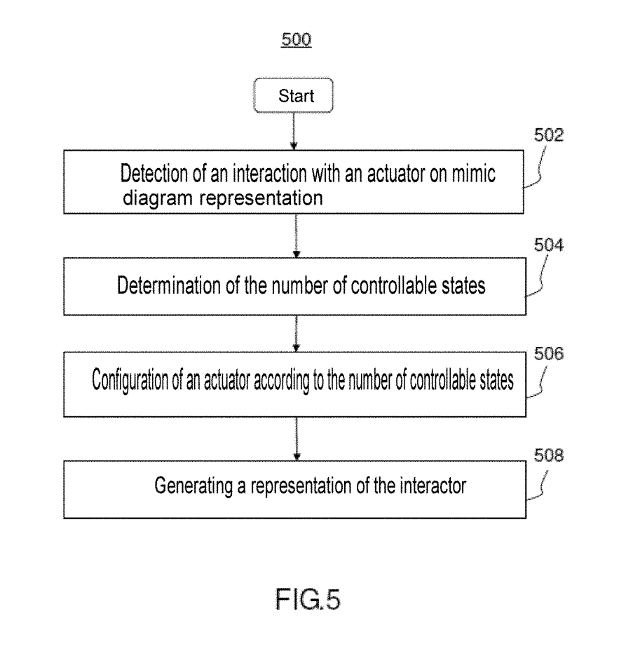

FIG. 5 shows the steps of the method (500) for configuring a multi-state interactor according to the invention. The method offers a dynamic configuration of the multi-state interactor which allows the pilot to select commands by a so-called “secure” gesture of sliding type.

In a first step (502), the method detects an interaction with an actuator represented on a mimic diagram of a system of an aircraft. The step of detection of an interaction with the actuator can consist in detecting a press of single-touch type on the actuator.

In a subsequent step (504), the method determines the number of controllable states of an element of the system of the aircraft linked with the actuator. The step of determination of the number of controllable states can consist in identifying the element of the system of the aircraft which is controlled by the actuator.

Based on the number of controllable states, the method, in a subsequent step (506), configures an interactor, then generates (508) a representation of the interactor which includes the commands of the element of the system of the aircraft.

The step of configuration (506) of the interactor can consist in configuring an interactor having one or more sliders as a function of the number of controllable states, and the step of generation (508) of a representation can consist in generating a touch cursor composed of one or more sliders.

The representation of a multi-state interactor can be a single representation for any interactor having the same number of controllable states, whatever the controlled element may be of a system of the aircraft, such as the declination of multi-branch interactors of FIG. 4. Thus, a three-state interactor can always have a three-branch star representation whatever the element controlled by an actuator, whether the element is a valve, a pump, a gate or a generator.

The representation of an interactor having the same number of states can vary, either from one element to another for one and the same system, or from one system to another. Thus, a three-state interactor can have a three-branch star representation for an element of the electrical system for example and a different representation for an element of the fuel system.

In one embodiment, the step of generating (508) a representation of the interactor consists in juxtaposing the representation of the interactor with the representation of the actuator. The juxtaposition of the representation of the interactor with the representation of the actuator can be done on the same screen as the display of the mimic diagram representation of the system of the aircraft.

In one embodiment, the step of configuration (506) of the interactor can consist in determining the current state, and the step of generation of a representation of the interactor consists in adapting the representation as a function of the current state.

The method of the invention can comprise an additional step of determining, on the representation of the interactor, that a command is selected, and in applying the selected command to the corresponding element of the system of the aircraft. After this step, if the command is executed, the method updates the mimic diagram representation of the system of the aircraft, the updating consisting in modifying the representation of the state of the actuator according to its real state following the execution of the selected command, and in removing or replacing the representation of the interactor used to select the command. In one embodiment, the replacement of the interactor consists in adding an appropriate label to the mimic diagram of the system when the selected command corresponds to a non-nominal state.

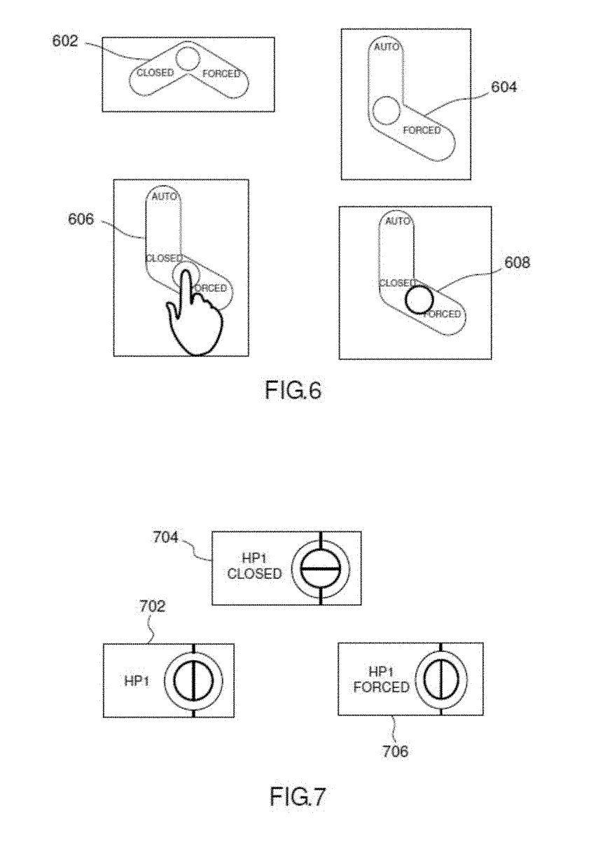

FIG. 6 illustrates, for a three-state interactor, different steps of display of the selection of a command. In the example, a first state (602) shows an interactor which displays two states, “CLOSED” and “FORCED”, for an element which is in an initial “AUTO” state (not displayed). If the CLOSED state is selected, then, on the next interaction with the actuator, the representation of the interactor will be updated to display an interactor (604) having two states, “AUTO” and “FORCED”. Upon the selection of the new command, the point of interaction is displaced on the slider to the destination label “FORCED”, and the current state “CLOSED” appears on the interactor. Advantageously, to highlight the command which will be active at the moment when the interaction is released, the destination label and/or the point of interaction can be highlighted, with a coloured outline, in a thicker font to clearly highlight the command which will be selected. Once the point of interaction on the interactor is released, the representation consists in displaying the state of the system of the aircraft with a label corresponding to the command.

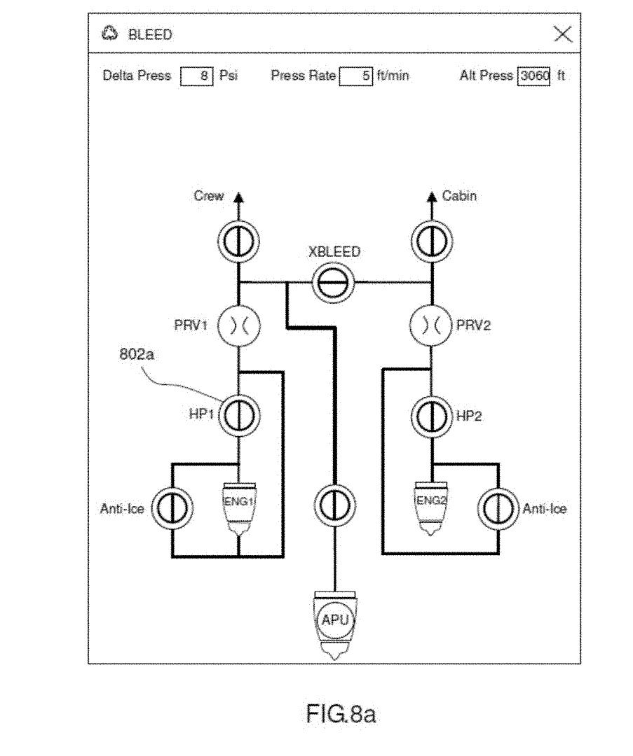

FIG. 7 illustrates mimic diagram representations of an actuator with the display of a label of the state of a command, according to the invention. In an advantageous embodiment, the command label display logic draws from the well known display logic called “dark cockpit”, which aims to not display a label for a nominal state (702), but only display a label for a non-nominal state (704, 706), so as not to overload the mimic diagram with information, by highlighting only the non-nominal states. Advantageously, in one embodiment, a label can be displayed transiently upon a selection of an actuator presented in the nominal state, to ensure feedback to the pilot.

The person skilled in the art knows that the dark cockpit logic consists, on a physical overhead panel, in leaving a knob off if the associated system is operating nominally and doing so whatever its state. Thus, systems having different nominal states, ON for one and OFF for the other, both remain off. A pilot can thus, in a single glance, check, by the fact that no light is switched on, that all is okay. The examples of FIG. 7 are not limiting and any other form of command label display can be derived for a logic of dark cockpit type. Generally, the colour green is used on the SYSTEM pages to represent the actuators (310, 702) which are in a nominal state. Also, any command label can be displayed in any other colour, light intensity, any form of character in order to emphasize the visual effect and draw the attention of the pilot with a minimum of information displayed.

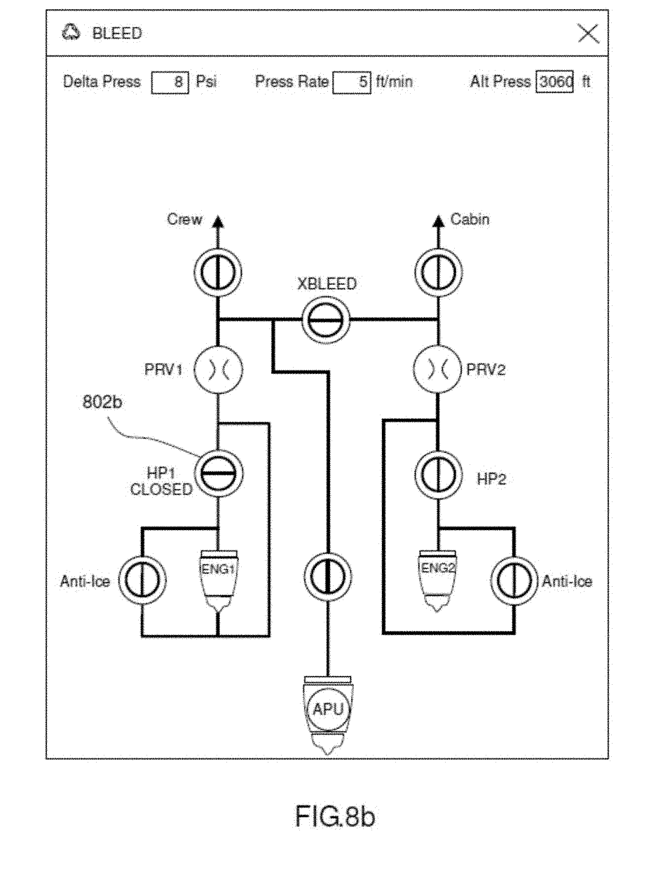

FIGS. 8a and 8b illustrate the display of a mimic diagram of a hydraulic system of an aircraft, for FIG. 8a before and for FIG. 8b after an interaction on an actuator (802a and 802b respectively) according to the method of the invention. It can be seen that the pilot can thus distinguish “at a glance” a situation which is different from the nominal state (802a) where there is no label displayed, from a non-nominal case in which the label is displayed alongside the actuator (CLOSED label displayed alongside 802b).

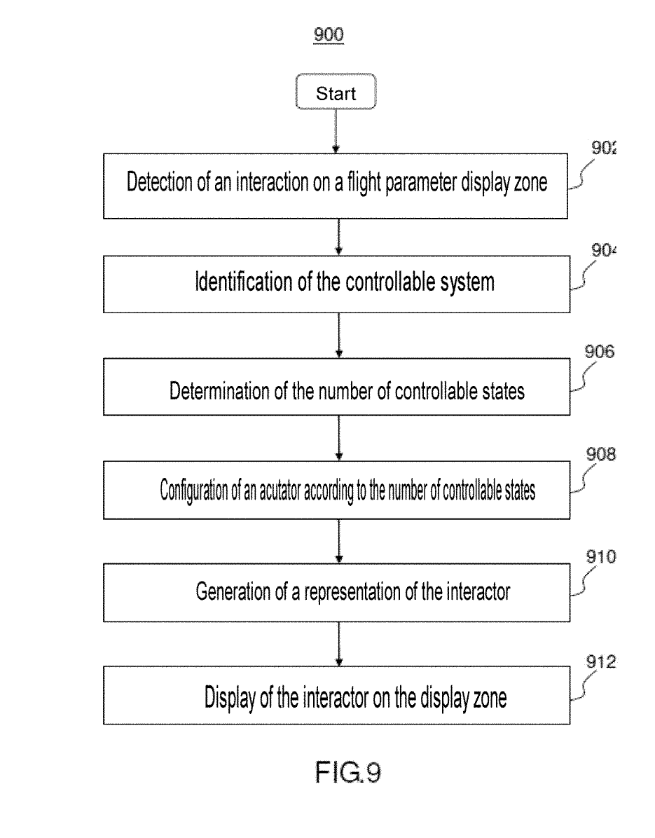

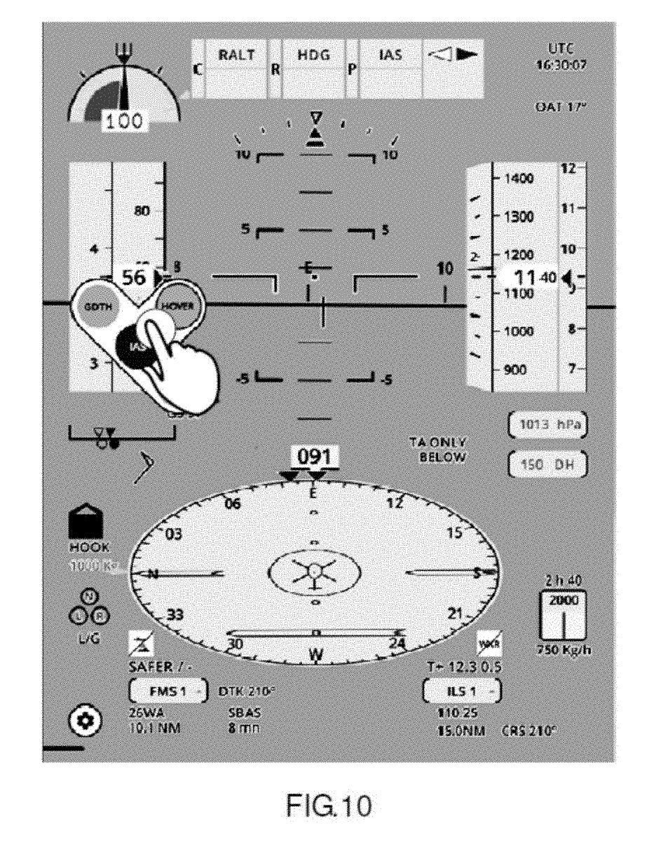

FIG. 9 shows the steps of the method of the invention according to another embodiment, and FIG. 10 illustrates an implementation of the method of FIG. 9 for a touch surface displaying the four basic flight parameters. Generally, in a known aircraft, the four basic parameters are presented on a screen always in the same way, namely: the artificial horizon at the centre, speed on the left, the altitude on the right and the direction below.

According to the principle of the invention, each parameter will define an interaction zone, and in a first step (902), the method detects an interaction with a zone. The step of detection of an interaction with a zone of the surface can consist in detecting a press of single-touch type.

Then, the method identifies (904) the controllable system corresponding to the activated zone, and determines the number of controllable states of this system (906).

On the basis of the number of controllable states, the method, in a subsequent step (908), configures an actuator, then generates (910) a representation of the interactor which includes the commands of the system linked with the activated zone.

In the example of FIG. 10, the activated zone is that of the speed scale and the interactor is configured to have four controllable states, which are the control states of the automatic pilot acting on the speed of the aircraft.

The different control modes are:
GDTH for “Guidance Down to Hover” controlling the transitional mode of reduction of altitude and speed to a hover mode;
hover or stationary mode controlling the maintaining of altitude;
IAS for “Indicated Air Speed” controlling the maintaining of speed; and
OFF for stopping the automatic speed control mode.

The method, in another step (912), displays the interactor on the activated display zone to allow the pilot to select the desired command by secure sliding.

Thus, advantageously, the method (900) can be implemented to propose, on a touch surface, a human-machine interface having distinct functional zones with which a pilot can interact, each zone allowing to display, in a concise and integrated manner, the controls and the state of a set of flight parameters of an aircraft.

The present invention can be implemented from hardware and/or software elements. It can be available as computer program product on a computer-readable medium. The medium can be electronic, magnetic, optical or electromagnetic. Physically, the computer is configured to operate the method described can be implemented on a tablet or portable computer (or any other computation means external to the avionics, for example via remote access). It can also rely on ground computation infrastructures, based on distributed or massively parallel architectures. In one embodiment, the method is implemented by computer. A computer program product is described, said computer program comprising code instructions for performing one or more of the steps of the method, when said program is run on a computer. In one embodiment, the system for implementing the invention comprises a computer-readable storage medium (RAM, ROM, flash memory or other memory technology, for example disk medium or another non-transient, computer-readable storage medium), coded with a computer program (that is to say several executable instructions) which, when it is executed on a processor or several processors, performs the functions of the embodiments described previously. As an example of hardware architecture suitable for implementing the invention, a device can comprise a communication bus to which are linked a central processing unit or microprocessor (CPU, acronym for “Central Processing Unit”), which processor can be “multi-core” or “many-core”; a read-only memory (ROM) that can include the programs necessary to the implementation of the invention; a random access memory or cache memory (RAM) comprising registers suitable for storing variables and parameters created and modified during the execution of the abovementioned programs; and a communication or I/O (“input/output”) interface suitable for transmitting and receiving data.

In the case where the invention is implanted on a reprogrammable computation machine (for example an FPGA circuit), the corresponding program (that is to say the sequence of instructions) can be stored in or on a removable storage medium (for example an SD card or a mass storage medium such as a hard disk, for example an SSD) or non-removable storage medium, volatile or non-volatile, this storage medium being partially or totally readable by a computer or a processor. The computer-readable medium can be transportable or communicable or mobile or transmissible (i.e. by a 2G, 3G, 4G, Wifi, BLE, fibre optic or other such telecommunication network).

The reference to a computer program which, when it is run, performs any of the functions described previously, is not limited to an application program running on a single host computer. On the contrary, the terms computer program and software are used here in a general sense to refer to any type of computer code (for example application software, firmware, microcode, or any other form of computer instruction, such as web services or SOA or via application programming interfaces API) which can be used to program one or more processors to implement aspects of the techniques described here. The computer means or resources can in particular be distributed (“cloud computing”), possibly with or according to peer-to-peer and/or virtualization technologies. The software code can be executed on any appropriate processor (for example a microprocessor) or processor core or a set of processors, whether they be provided in a single computation device or distributed between several computation devices (for example as possibly accessible in the environment of the device). Securing technologies (crypto-processors, possibly biometric authentication, encryption, chip card, etc.) can be used.

1. A method implemented by computer for managing systems, the method comprising at least a step of displaying a mimic diagram representation of the state of at least one system, said mimic diagram representation being composed of actuators and of links between the actuators, an actuator representing an element of the system that can be controlled, the method further comprising the steps of:
detecting an interaction with an actuator;
determining a number of controllable states for an element of the system represented by the actuator;
configuring a multi-state interactor as a function of the number of controllable states and of the state of said system; and
generating on the state mimic diagram representation, a representation of the multi-stage interactor including the commands available for controlling said element according to the state of said system.

2. The method according to claim 1, wherein the step of generating a representation of the interactor on the state mimic diagram representation consists in juxtaposing the representation of the multi-state interactor with the representation of the actuator.

3. The method according to claim 2, wherein the step of juxtaposing the representation of the interactor on the state mimic diagram representation consists in displaying said multi-state interactor on one and the same screen as the display of the state mimic diagram representation of said system.

4. The method according to claim 1, wherein the step of configuring the multi-state interactor consists in configuring an interactor having one or more sliders as a function of the number of controllable states, and wherein the step of generating a representation of the interactor on the state mimic diagram representation consists in generating a cursor.

5. The method according to claim 4, wherein the cursor is composed of a slider with two commands for two controllable states or two sliders with three commands for three controllable states or three sliders with four commands for four controllable states.

6. The method according to claim 1, wherein the step of configuring the multi-state interactor further comprises a step of determining the current state of said system and wherein the step of generating a representation of the multi-state interactor comprises a step for adapting the representation of the multi-state interactor as a function of the current state of said system.

7. The method according to claim 1, wherein the step of detecting an interaction with the actuator consists in detecting a press of single-touch type on the actuator.

8. The method according to claim 1, wherein the step of determining the number of controllable states comprises a step of identifying the element of said system which is controlled by the actuator.

9. The method according to claim 1, further comprising a step of determining that a command on the representation of the interactor is selected, and a step of applying the selected command to said element of said system.

10. The method according to claim 9, further comprising a step of updating the mimic diagram representation of the system if the command is executed, the updating consisting in modifying the representation of the state of the actuator according to its real state, and in replacing the representation of the multi-state interactor with an appropriate label when the selected command corresponds to a non-nominal state.

11. The method according to claim 1 implemented for an aircraft system, wherein the mimic diagram representation is a representation of a utility system of an aircraft such as, for example, an electrical system, a hydraulic system, a fuel or oxygen supply system, a conditioned air system, or a lighting system.

12. The method according to claim 11, wherein the element that can be controlled represented by an actuator is for example a valve, a pump, a gate, a generator or windscreen wipers.

13. The method according to claim 11, wherein the step of displaying a mimic diagram representation of the state of at least one system of the aircraft is a step of displaying a representation of flight parameters, said representation defining interactive display zones for each parameter, the method comprising the steps of:
detecting an interaction with a flight parameter display zone;
identifying the controllable system of the aircraft corresponding to the parameter of said display zone;
determining a number of controllable states for said system;
configuring a multi-state interactor as a function of the number of controllable states and of the state of said system; and
generating on the state mimic diagram representation, a representation of the multi-state interactor including the commands available for controlling said system according to the state of said system.

14. The method according to claim 13, wherein the flight parameters are parameters relating to the altitude, speed and direction.

15. A computer program product, said computer program comprising code instructions for performing the steps of the method according to claim 1, when said program is run on a computer.

16. A device for managing systems, comprising at least one control screen suitable for displaying a mimic diagram representation of the state of at least one system, said mimic diagram representation being composed of actuators and of links between the actuators, the device comprises means for:
detecting an interaction on an actuator;
determining a number of controllable states for an element of the system represented by the actuator;
configuring a multi-state interactor as a function of the number of controllable states and of the state of said system; and
generating, on the state mimic diagram representation, a representation of the multi-state interactor including the commands available for controlling said element according to the state of said system.

17. The device according to claim 16, wherein the system is an aircraft system.

18. The device for managing the systems of an aircraft, comprising at least one screen for displaying a representation of flight parameters, said representation defining interactive display zones for each parameter, the device comprising means for:
detecting an interaction with a flight parameter display zone;
identifying the controllable system of the aircraft corresponding to the parameter of said display zone;
determining a number of controllable states for said system;
configuring a multi-state interactor as a function of the number of controllable states and of the state of said system; and
generating, on the state mimic diagram representation, a representation of the multi-state interactor including the commands available for controlling said system according to the state of said system.
